(19) United States
(12) Patent Application Publication
(10) Pub. No.: US 2014/0234628 A1
(43) Pub. Date: Aug. 21, 2014

(54) CONDUCTIVE BELT AND ELECTROPHOTOGRAPHIC APPARATUS

(71) Applicant: Canon Kabushiki Kaisha, Tokyo (JP)

(72) Inventor: Masahiro Takenaga, Yokohama-shi (JP)

(73) Assignee: Canon Kabushiki Kaisha, Tokyo (JP)

(21) Appl. No.: 14/260,106

(22) Filed: Apr. 23, 2014

Related U.S. Application Data
(63) Continuation of application No. PCT/JP2013/006993, filed on Nov. 28, 2013.

(30) Foreign Application Priority Data
Dec. 7, 2012 (JP) 2012-268601

(51) Int. Cl. B32B 9/04; G03G 15/01

(52) U.S. Cl. CPC G03G 15/162
USPC 428/411.1; 399/302

(57) ABSTRACT

Provided is a conductive belt in which a time-dependent fluctuation in electrical resistance value is suppressed even in long-term use. The conductive belt is a conductive belt for electrophotography, including: a matrix containing polyester; and a domain containing polyether ester amide, in which the conductive belt further includes a particle containing a silicone resin; the domain further contains a salt that can dissociate into a cation and an anion; and the anion has a predetermined structure.

### CROSS-REFERENCE TO RELATED APPLICATIONS

This application is a continuation of International Application No. PCT/JP2013/006993, filed Nov. 28, 2013, which claims the benefit of Japanese Patent Application No. 2012-268601, filed Dec. 7, 2012.

### BACKGROUND OF THE INVENTION

1. Field of the Invention

The present invention relates to a conductive belt, preferably a conductive belt to be used for, for example, an intermediate transfer belt for an electrophotographic apparatus. The present invention also relates to an electrophotographic apparatus.

2. Description of the Related Art

A belt to be used for, for example, an intermediate transfer belt for an electrophotographic apparatus has a function of transferring toner having a charge from a photosensitive member onto paper, and hence needs to have certain conductivity.

To that end, it is known that a conductive belt is formed using a conductive polymer blended with a salt that can dissociate into an anion and a cation (Japanese Patent Application Laid-Open No. 2008-274286).

However, when the conductive belt made conductive by an action of ions as described above is used as, for example, an intermediate transfer belt, and a transfer electric field is repeatedly applied to the conductive belt to form an electrophotographic image, the ions in the conductive belt gradually move in the conductive belt to migrate (hereinafter sometimes referred to as “bleed”) to a surface side of the conductive belt. As a result, an electrical resistance value of the conductive belt may fluctuate in a time-dependent manner.

To cope with such problem, Japanese Patent Application Laid-Open No. 2008-274286 discloses the following conductive polymer as a conductive polymer composition that may be used for a conductive belt or the like. The conductive polymer is formed of a continuous phase constituted of a polyester-based thermoplastic elastomer and one discontinuous phase constituted of a polyoxyalkylene-based polymer. The polymer constituting the discontinuous phase is blended with a salt that can dissociate into a cation and an anion, and the polymer constituting the discontinuous phase is increased in affinity for the salt as compared to that of the polymer constituting the continuous phase. Thus, the salt is localized in the discontinuous phase, and the salt is hardly dispersed in the continuous phase, resulting in suppression of the movement of the salt to the outside of the phase. Consequently, the environmental dependency and time-dependent change of the electrical resistance value of the conductive polymer are suppressed.

### SUMMARY OF THE INVENTION

However, according to the results of studies made by the inventors of the present invention, even in the conductive belt formed using the conductive polymer according to the invention disclosed in Japanese Patent Application Laid-Open No. 2008-274286, the suppressive effect on a time-dependent increase in electrical resistance value is a limited one. Particularly in recent years, an increase in electrophotographic image-forming process speed and an increase in the lifetime of an electrophotographic apparatus have been demanded, and under this situation, the voltage to be applied to an intermediate transfer belt has tended to increase. Accordingly, the inventors of the present invention have recognized that it is necessary to develop a conductive belt for electrophotography that is additionally improved in stability over time of the electrical resistance value.

In view of the foregoing, the present invention is directed to providing a conductive belt in which a time-dependent fluctuation in electrical resistance value is suppressed even in long-term use. In addition, the present invention is directed to providing an electrophotographic apparatus capable of stably forming a high-quality electrophotographic image.

According to one aspect of the present invention, there is provided a conductive belt for electrophotography, including:

a matrix containing polyester; and

a domain containing polyether ester amide,

in which:

the conductive belt further includes a particle containing a silicone resin;

the domain further contains a salt that dissociates into a cation and an anion;

the anion is represented by the following formula (1) or the following formula (2); and

the silicone resin contains a structural unit represented by the following formula (3).

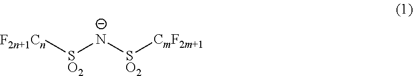

In the formula (1), m and n each independently represent an integer of 1 to 4.

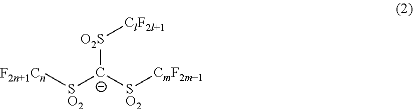

In the formula (2), l, m, and n each independently represent an integer of 1 to 4.

R₀—SiO_{3/2} (3)

In the formula (3), R₀ represents a hydrocarbon group having 1 to 6 carbon atoms.

In addition, according to another aspect of the present invention, there is provided an electrophotographic apparatus, including the conductive belt as an intermediate transfer belt.

According to the present invention, it is possible to provide a conductive belt in which an increase in electrical resistance value during continuous energization is further suppressed.

### BRIEF DESCRIPTION OF THE DRAWINGS

FIG. 1 is a schematic sectional view illustrating an example of a full-color electrophotographic apparatus that utilizes an electrophotographic process.

FIG. 2 is an explanatory diagram of a conductive belt according to the present invention.

### DESCRIPTION OF THE EMBODIMENTS

In order to achieve the above-mentioned objects, the inventors of the present invention have made extensive studies on a conductive belt including polyether ester amide, containing a salt that can dissociate into a cation and an anion, as a discontinuous phase (hereinafter also referred to as “domain”) in a matrix formed of thermoplastic polyester.

In the course of the studies, the inventors of the present invention have estimated that the reason why the suppressive effect on a time-dependent change in electrical resistance of the conductive belt constituted of the conductive polymer composition disclosed in Japanese Patent Application Laid-Open No. 2008-274286 is a limited one is that, in the conductive polymer, no measure is taken against the salt that has bled out of the domain containing a polyether ester amide in which the salt is localized.

That is, it is considered that the salt that has bled out of the discontinuous phase made of a polyether ester amide moves toward the surface side of the conductive belt to cause a time-dependent fluctuation in the electrical resistance of the conductive belt.

In view of the foregoing, the inventors of the present invention have considered that the movement of the salt in the conductive belt can be suppressed and an additional improvement in time-dependent stability of the electrical resistance can be achieved by allowing a substance, having a function that enables the trapping of a salt or ion that has bled out of the discontinuous phase, to exist in the conductive belt.

Based on such consideration, the inventors of the present invention have made studies on causing the ion to be allowed to exist in the conductive belt to coexist with a particle having a high affinity for the ion in the conductive belt. Specifically, the inventors have further incorporated a silicone resin-containing particle into a conductive belt including a matrix containing polyester and a domain containing polyether ester amide, the domain containing a salt that can dissociate into an anion and a cation. As a result, the inventors have succeeded in obtaining a conductive belt in which a time-dependent fluctuation in electrical resistance can be additionally suppressed. The present invention has been accomplished based on such experimental results.

A conductive belt according to an embodiment of the present invention is described in detail with reference to FIG. 2. It is to be noted that the present invention is not limited to the following embodiment.

A conductive belt 100 according to the present invention includes a matrix 102 containing a polyester and a domain 101 containing a polyether ester amide (hereinafter sometimes referred to as “PEEA”). In addition, the domain 101 contains a salt that can dissociate into an anion 202 and a cation 203. FIG. 2 illustrates a state in which the salt has dissociated in the domain. The conductive belt 100 further contains silicone resin-containing a particle 201.

Hereinafter, those materials are described.

<Polyester>

The polyester contained in the matrix may be produced by condensation polymerization using a dicarboxylic acid component and a dihydroxy component, an oxycarboxylic acid component, a lactone component, or a plurality of these components. In addition, from the viewpoints of, for example, crystallinity and heat resistance, the polyester is preferably at least one polyester selected from polyalkylene naphthalate and polyalkylene terephthalate. From the viewpoints of crystallinity and heat resistance, an alkylene in the polyalkylene naphthalate and the polyalkylene terephthalate preferably has 2 or more and 16 or less carbon atoms. Of those, polyethylene naphthalate or polyethylene terephthalate is more suitably used.

One kind of the thermoplastic polyesters may be used alone, or two or more kinds thereof may be used in combination as a blend or an alloy. It is to be noted that the polyethylene naphthalate may be specifically exemplified by commercially available TN-8050SC (trade name; manufactured by Teijin Chemicals Ltd.). In addition, the polyethylene terephthalate is specifically exemplified by commercially available TR-8550 (trade name; manufactured by Teijin Chemicals Ltd.).

From the viewpoint of maintaining the strength of the conductive belt, the amount of the polyester is set to preferably 50 mass % or more, more preferably 60 mass % or more with respect to the total amount of the polyester and polyether ester amide (PEEA) to be described later.

<Polyether Ester Amide (PEEA)>

An example of the PEEA may be a compound whose main constituent is a copolymer formed of a polyamide block unit such as nylon 6, nylon 66, nylon 11, or nylon 12 and a polyether ester unit.

There is given, for example, a copolymer derived from a lactam (such as caprolactam or lauryllactam) or an aminocarboxylic acid salt, polyethylene glycol, and a dicarboxylic acid. Specific examples of the dicarboxylic acid include terephthalic acid, isophthalic acid, adipic acid, azelaic acid, sebacic acid, undecanedioic acid, and dodecanedioic acid.

A production method for the PEEA is not particularly limited, and for example, the PEEA may be produced by a known polymerization method such as melt polymerization. It is to be appreciated that the PEEA is not limited to those compounds, and one kind of the PEEAs may be used alone, or two or more kinds thereof may be used in combination as a blend or an alloy. In addition, commercially available PEEA (trade name: PELESTAT NC6321, manufactured by Sanyo Chemical Industries, Ltd.) or the like may be used.

The amount of the PEEA is preferably set to 3 mass % or more and 30 mass % or less with respect to the total mass of a resin composition constituting the conductive belt. The PEEA functions as a conductive agent, and hence the electrical resistance value of the conductive belt can be properly reduced by setting the content of the PEEA to 3 mass % or more. On the other hand, the content of the polyester required for maintaining the strength of the conductive belt can be sufficiently secured by setting the content of the PEEA to 30 mass % or less.

<Salt>

The salt is a substance that expresses conductivity by dissociating into a cation and an anion in a resin. In the present invention, it is preferred to use a salt that has high compatibility with the polyether ester amide contained in the domain.

In addition, the salt used in the present invention is such that the anion to be generated by the dissociation thereof has a structure represented by the following formula (1) or the following formula (2).

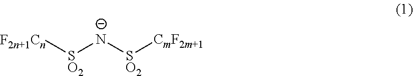

In the formula (1), m and n each independently represent an integer of 1 to 4.

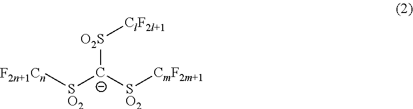

In the formula (2), l, m, and n each independently represent an integer of 1 to 4.

The cation that pairs with the anion represented by the formula (1) or the formula (2) is not particularly limited, and examples thereof include: cations of metals such as alkali metals, alkaline-earth metals, transition metals, and amphoteric metals; and non-metal cations such as quaternary ammonium ions, pyridinium ions and derivatives thereof, and imidazolium ions and derivatives thereof. Of those, an alkali metal is preferred because its ionization energy is low and hence the salt can easily dissociate to give the cation.

From the viewpoint of maintaining resistance uniformity, the amount of the salt is preferably set to 0.1 mass % or more with respect to the total amount of the resin composition constituting the conductive belt. In addition, even when the salt is added in an amount of more than 10 mass %, a resistance-reducing effect based on the increase in blending amount is hardly obtained, and hence the amount is preferably set to 10 mass % or less.

<Silicone Resin-Containing Particle>

The silicone resin contained in the silicone resin-containing particle is described. The silicone resin used in the present invention contains a structural unit represented by the following formula (3).

R₀—SiO_{3/2} (3)

In the formula (3), R₀ represents a hydrocarbon group having 1 to 6 carbon atoms.

Herein, the silicone resin containing the structural unit represented by the formula (3) has only to be one having the structural unit represented by the formula (3) as an essential structural unit, and also encompasses a polymer obtained by combining therewith a structural unit represented by SiO_{4/2}, (R₀)₂—SiO_{2/2}, or (R₀)₃—SiO_{1/2}. In addition, the silicone resin also encompasses a polymer obtained by combining the structural unit represented by the formula (3) with at least one structural unit selected from structural units represented by (C₆H₅)R₀—SiO, (C₆H₅)₂SiO, and (R₀)₂—SiO.

A production method for the silicone resin-containing particle is not particularly limited, but it is preferred to employ a method involving hydrolyzing a hydrolyzable silane, subjecting the hydrolysate to a condensation reaction to generate a nucleus, and growing the nucleus while allowing the condensation reaction to further proceed, thereby obtaining the particle. The silicone resin-containing particle may be exemplified by “Tospearl” (trade name; manufactured by Momentive Performance Materials).

The average particle diameter of the silicone resin-containing particle is preferably set within the range of 1 to 10 μm, in order to efficiently trap ions that have exited the domain and maintain the surface smoothness of the conductive belt.

It is to be noted that the particle diameter of the silicone resin-containing particle is a value obtained by measuring, with a scanning electron microscope (SEM), the minor axis and major axis of a primary particle that does not overlap other particle, followed by the calculation of (minor axis+major axis)/2. This operation is performed for arbitrarily selected 20 silicone resin-containing particle, and the arithmetic average value of the resultant particle diameters of the particle is defined as the average particle diameter of the silicone resin.

In addition, from the viewpoints of efficiently trapping the salt and suppressing a time-dependent change in electrical resistance, the amount of the silicone resin-containing particle is preferably set to 33 parts by mass or more and 500 parts by mass or less with respect to 100 parts by mass of the salt, in particular, 100 parts by mass or less with respect to 100 parts by mass of the salt.

The anion represented by the formula (1) or the formula (2) described above, which contains multiple perfluoroalkyl groups (—CₙF₂ₙ₊₁), has high hydrophobicity, and hence the salt containing this anion is considered to have a high affinity for the silicone resin-containing particle, which have high hydrophobicity.

In addition, when the conductive belt including the matrix containing polyester and the domain containing PEEA is produced, the polyester and the PEEA need to be melt-kneaded. In this case, when the silicone resin-containing particle has excellent heat resistance, the particle can be more satisfactorily dispersed in the conductive belt including the matrix containing polyester and the domain containing PEEA.

The hydrophobicity of the silicone resin-containing particle depends on the structure “R₀” in the formula (3). Thus, a hydrocarbon group having 1 to 6 carbon atoms, which has high hydrophobicity, is used as “R₀”. The hydrocarbon group may be any of linear, chain-like, and cyclic hydrocarbon groups. Examples thereof include a methyl group (—CH₃), an ethyl group (—CH₂CH₃), a propyl group (—CH₂CH₂CH₃), a butyl group (—CH₂CH₂CH₂CH₃), and a phenyl group.

<Additive>

The conductive belt according to the present invention may contain an additive as an additional component in such a range that the effect of the present invention is not impaired. Specific examples of such additive include an antioxidant (such as a hindered phenol-based antioxidant or a phosphorus- or sulfur-based antioxidant), a UV absorber, an organic pigment, an inorganic pigment, a pH adjustor, a crosslinking agent, a compatibilizer, a release agent, a coupling agent, a lubricant, a conductive filler (such as carbon black, carbon fibers, conductive titanium oxide, conductive tin oxide, or conductive mica), and an ionic liquid. One kind of those additives may be used alone, or two or more kinds thereof may be used in combination.

<Conductive Belt>

The conductive belt according to the present invention is, for example, formed from a resin composition obtained by melt-kneading the components described above. The polyester and the polyether ester amide have low compatibility with each other. Accordingly, through the melt-kneading of a mixture of the polyester and the PEEA, there is obtained a resin composition having a micro-scale structure in which a domain containing the PEEA is dispersed in a matrix containing the polyester. In addition, at the time of the melt-kneading, by allowing the salt having high compatibility with the PEEA as described above to coexist, the salt can be localized in the domain containing the PEEA.

Then, a conductive belt having a seamless shape can be formed by pelletizing the resin composition including the matrix and the domain described above and molding the pellets by a known molding method such as a continuous melt extrusion method, an injection molding method, a stretch blow molding method, or an inflation molding method.

The molding method for the seamless belt is more preferably a continuous melt extrusion method or a stretch blow molding method. Examples of the continuous melt extrusion method include: a downwardly extruding internal cooling mandrel system that allows precise control of the inner diameter of an extruded tube; and a vacuum sizing system. A production method for the conductive belt based on the stretch blow molding method includes, for example, the following steps of: molding the resin composition into a preform; heating the preform; mounting the preform after the heating into a die for seamless belt molding, followed by the injection of a gas into the die for molding to perform stretch molding; and cutting a stretch molded article obtained by the stretch molding to obtain a seamless belt.

The thickness of the conductive belt is preferably 40 to 500 μm, particularly preferably 50 to 120 μm. In addition, the conductive belt may be subjected to surface treatment such as the application of a treatment agent or polishing treatment in order to improve the external appearance of the surface and improve the releasability of toner or the like.

Applications of the conductive belt according to the present invention are not particularly limited, but the conductive belt is suitably used for, for example, an intermediate transfer belt or a conveying transfer belt. The conductive belt can be particularly suitably used as an intermediate transfer belt. In addition, when the conductive belt is used as an intermediate transfer belt, the conductive belt preferably has a surface specific resistivity of 1×10⁶ Ω/□ or more and 1×10¹⁴ Ω/□ or less. When the surface specific resistivity is 1×10⁶ Ω/□ or more, the resistance is prevented from remarkably reducing, a transfer electric field can be easily obtained, and the occurrence of a white spot or coarseness in an image can be effectively prevented. When the surface specific resistivity is 1×10¹⁴ Ω/□ or less, an increase in transfer voltage can be suppressed more effectively, and an increase in size of a power source and an increase in cost can be effectively suppressed.

<Electrophotographic Apparatus>

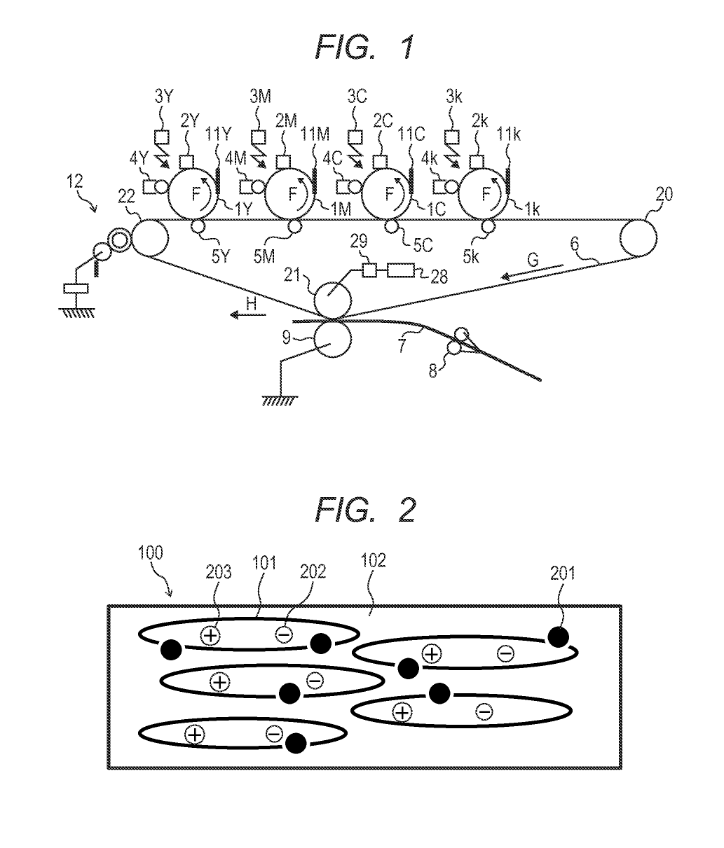

An electrophotographic apparatus is described. First, an electrophotographic apparatus according to this embodiment is described with reference to FIG. 1. The electrophotographic apparatus according to this embodiment has the so-called tandem-type configuration in which electrophotographic stations for multiple colors are disposed by being arranged in the rotation direction of the conductive belt of the present invention (hereinafter referred to as intermediate transfer belt). It is to be noted that, in the following description, reference symbols for members for yellow, magenta, cyan, and black colors are affixed with Y, M, C, and k, respectively, but the affixes are sometimes omitted for like members.

Reference symbols 1Y, 1M, 1C, and 1k in FIG. 1 denote photosensitive drums (photosensitive members, image bearing members), and around the photosensitive drums 1, there are disposed charging apparatuses 2Y, 2M, 2C, 2k, exposing apparatuses 3Y, 3M, 3C, 3k, developing apparatuses 4Y, 4M, 4C, 4k, and an intermediate transfer belt (intermediate transfer member) 6. The photosensitive drums 1 are driven to rotate in the direction indicated by an arrow F at a predetermined circumferential speed (process speed). The charging apparatuses 2 charge the circumferential surfaces of the photosensitive drums 1 to a predetermined polarity and electric potential (primary charging). Laser beam scanners serving as the exposing apparatuses 3 output laser light that is on/off-modulated according to image information inputted from an external device (not shown) such as an image scanner or a computer, to thereby subject the charging treatment surfaces on the photosensitive drums 1 to scanning exposure. The scanning exposure results in the formation of electrostatic latent images according to image information of interest on the surfaces of the photosensitive drums 1.

The developing apparatuses 4Y, 4M, 4C, 4k contain toners containing color components for yellow (Y), magenta (M), cyan (C), and black (k), respectively. In addition, the developing apparatuses 4 to be used are selected based on the image information, a developer (toner) is developed on the surfaces of the photosensitive drums 1, and the electrostatic latent images are visualized as toner images. In this embodiment, as just described, a reversal development system in which development is performed by causing toner to adhere to the exposed portions of the electrostatic latent images is used. In addition, such charging apparatuses, exposing apparatuses, and developing apparatuses constitute electrophotographic unit.

In addition, the intermediate transfer belt 6 is an endless belt, is provided so as to abut on the surfaces of the photosensitive drums 1, and is stretched by multiple stretching rollers 20, 21, 22. In addition, the intermediate transfer belt 6 is configured to rotate in the direction indicated by an arrow G. In this embodiment, the stretching roller 20 is a tension roller configured to control the tension of the intermediate transfer belt 6 at a constant level, the stretching roller 22 is a driving roller for the intermediate transfer belt 6, and the stretching roller 21 is an opposing roller for secondary transfer. In addition, at primary transfer positions opposed to the photosensitive drums 1 across the intermediate transfer belt 6, primary transfer rollers 5Y, 5M, 5C, 5k are disposed, respectively.

The unfixed toner images of the respective colors respectively formed on the photosensitive drums 1 are subjected to electrostatic primary transfer onto the intermediate transfer belt 6 sequentially through the application of a primary transfer bias, which has a polarity opposite to the polarity of the charge of the toner, to the primary transfer roller 5 with a constant voltage source or a constant current source. Thus, a full-color image in which the unfixed toner images of the four colors are superimposed is obtained on the intermediate transfer belt 6. The intermediate transfer belt 6 rotates while bearing the toner image transferred from the photosensitive drums 1 as just described. For every rotation of the photosensitive drums 1 after the primary transfer, the surfaces of the photosensitive drums 1 are cleaned of transfer residual toner with a cleaning apparatus 11 to be repeatedly used in the image formation process.

In addition, at a secondary transfer position in the intermediate transfer belt 6, which faces a conveyance path for a recording material 7, a secondary transfer roller (transfer member) 9 is disposed so as be brought into pressure contact with the toner image-bearing surface side of the intermediate transfer belt 6. In addition, on the back surface side of the intermediate transfer belt 6 with respect to the secondary transfer position, the opposing roller 21 is provided, which serves as an opposite electrode for the secondary transfer roller 9 and to which a bias is applied. At the time of the transfer of the toner image on the intermediate transfer belt 6 onto the recording material 7, a bias having the same polarity as that of the toner is applied to the opposing roller 21 with transfer bias applying unit 28, and for example, a bias of −1,000 to −3,000 V is applied to cause a current of −10 to −50 μA to flow. The transfer voltage at this time is detected with high transfer voltage detecting unit 29. Further, on the downstream side with respect to the secondary transfer position, there is provided a cleaning apparatus (belt cleaner) 12 for removing toner remaining on the intermediate transfer belt 6 after the secondary transfer.

The recording material 7 introduced to the secondary transfer position is conveyed while being sandwiched at the secondary transfer position, and during the conveyance, the opposing roller 21 for the secondary transfer roller 9 is supplied with a constant voltage bias (transfer bias) controlled to a predetermined value from the secondary transfer bias applying unit 28. Through the application of the transfer bias having the same polarity as that of the toner to the opposing roller 21, the full-color image (toner image) formed of the four colors superimposed on the intermediate transfer belt 6 is transferred at once onto the recording material 7 at the transfer site. Thus, the full-color unfixed toner image is formed on the recording material. The recording material 7 onto which the toner image has been transferred is introduced into a fixing unit (not shown) and subjected to heat fixing.

### EXAMPLES

The present invention is specifically described below by way of Examples and Comparative Examples. However, the present invention is not limited thereto. It is to be noted that, in Examples and Comparative Examples, seamless belts for electrophotography, out of conductive belts, were produced, and surface specific resistivity (ρs) measurement used in Examples and Comparative Examples was performed as described below.

A high resistance meter (trade name: Hiresta UP Model MCP-HT450; manufactured by Mitsubishi Chemical Analytech Co., Ltd.) was used as a measurement apparatus. The measurement apparatus included a main electrode having an inner diameter of 50 mm, and a guard-ring electrode having an inner diameter of 53.2 mm. In addition, a probe having an outer diameter of 57.2 mm (trade name: UR-100; manufactured by Mitsubishi Chemical Analytech Co., Ltd.) was used. The measurement was performed in conformity with JIS-K6911. A voltage of 500 V was applied to a belt for 10 seconds, and surface specific resistivities were measured at four points along the direction of the circumference of the belt. Their average value was adopted. The value was defined as ρs (before continuous energization).

The seamless belts for electrophotography obtained in Examples and Comparative Examples were each mounted as an intermediate transfer belt onto the transfer unit of a tandem-type full-color electrophotographic apparatus (trade name: HP Color LaserJet CP4025dn; manufactured by Hewlett-Packard), which had the apparatus structure as illustrated in FIG. 1. Then, after 150,000-sheet printing, the ρs of the belt was measured by the same method as above. The value was defined as ρs (after continuous energization).

(Materials for Resin Compositions for Belts used in Examples and Comparative Examples)

Tables 1 to 4 show materials for resin compositions used in Examples and Comparative Examples to be described later. It is to be noted that Tables 5 and 7 show blends of materials for the examples.

TABLE 1
<Resin for matrix (polyester)>

| | |
|---|---|
| Resin for | Polyethylene naphthalate |
| matrix 1 | (trade name: TN-8050SC; manufactured by |
| | Teijin Chemicals Ltd.) |
| | Melting temperature (Tm) = 260° C. |
| Resin for | Polyethylene terephthalate |
| matrix 2 | (trade name: TN-8550; manufactured by |
| | Teijin Chemicals Ltd.) |
| | Tm = 260° C. |

TABLE 2
<Resin for domain (PEEA)>

| | |
|---|---|
| Resin for | Polyether ester amide |
| domain 1 | (trade name: PELESTAT NC6321; manufactured |
| | by Sanyo Chemical Industries, Ltd.) |
| | Tm = 203° C. |

TABLE 3
<Salt>

| | |
|---|---|
| Electrolyte 1 | Trifluoromethanesulfonylimide |
| | (trade name: EF-N112: manufactured by |
| | Mitsubishi Materials Electronic Chemicals |
| | Co., Ltd.) |
| Electrolyte 2 | Potassium |
| | bis(nonafluorobutanesulfonyl)imide |
| | (trade name: Ftergent 150, manufactured by |
| | NEOS COMPANY LIMITED) |
| Electrolyte 3 | Cesium |
| | tris(trifluoromethanesulfonyl)methide |
| | (Cs-TFSM: manufactured by Central Glass |
| | Co., Ltd.) |
| Electrolyte 4 | Potassium nonafluorobutanesulfonate |
| | (trade name: KFBS: manufactured by |
| | Mitsubishi Materials Electronic Chemicals |
| | Co., Ltd.) |

TABLE 4
<Particle>

| | |
|---|---|
| Particle 1 | Polymethylsilsesquioxane |
| | (trade name: Tospearl 120: manufactured by |
| | Momentive Performance Materials Japan LLC) |
| | Average particle diameter: 2 μm |
| Particle 2 | Polyphenylsilsesquioxane |
| | (manufactured by Gelest, Inc.) |
| Particle 3 | Zeolite |
| | (trade name: JC-20: manufactured by |
| | MIZUSAWA INDUSTRIAL CHEMICALS, LTD.) |
| | Average particle diameter: 2 μm |

### Example 1

A twin-screw extruder (trade name: TEX30a; manufactured by The Japan Steel Works, LTD.) was used, and heat melt-kneading was performed with the blend shown in Table 5 to prepare a resin composition. The heat melt-kneading temperature was adjusted so as to fall within the range of 260° C. or more to 280° C. or less, and the heat melt-kneading time was set to about 3 to 5 minutes. The resultant resin composition was pelletized, and the pellets were dried at a temperature of 140° C. for 6 hours.

Next, an injection molding apparatus (trade name: SE180D; manufactured by Sumitomo Heavy Industries, Ltd.) set to a cylinder preset temperature of 295° C. was used to prepare a preform. The injection molding die temperature in this case was set to 30° C. The preform was placed in a heating apparatus at a temperature of 500° C. to be softened, and then the preform was heated at 500° C.

After that, the preform was loaded into a primary blow molding machine. Then, in a blow die kept at a die temperature of 110° C., blow molding was performed with a stretching rod and the force of air (blow air inlet) at a preform temperature of 155° C., an air pressure of 0.3 MPa, and a stretching rod speed of 1,000 mm/s to provide a blow molded bottle. Both ends of the blow molded bottle were cut off to provide a seamless belt for electrophotography including a matrix containing polyester and a domain containing PEEA. The resultant conductive belt had a thickness of 70 μm. Table 6 shows the evaluation results of the conductive belt.

### Examples 2 to 5

Seamless belts for electrophotography were obtained in the same manner as in Example 1 with the exception that the blend of the resin composition was changed as shown in Table 5.

It is to be noted that, as the particle 2 used in Example 4, ones obtained by making only the particle 2 finer through the use of a pestle and mortar to an average particle diameter of 10 μm were used.

Table 6 shows the evaluation results of the conductive belts.

### Example 6

Pellets were produced by the same method as in Example 1 with the exception that the blend of the resin composition was changed as shown in Table 5. The pellets were loaded into an extruder, introduced into a circular die, melt-extruded into a tube shape, and cut to provide a conductive belt. Table 6 shows the evaluation results of the conductive belt.

TABLE 5

| Example | 1 | 2 | 3 | 4 | 5 | 6 |
|---|---|---|---|---|---|---|
| Resin for matrix 1 | 81 | — | 81 | 81 | 81 | 65 |
| Resin for matrix 2 | — | 81 | — | — | — | — |
| Resin for domain 1 | 15 | 15 | 15 | 15 | 15 | 30 |
| Electrolyte 1 | 3 | 2 | — | 2 | — | 3 |
| Electrolyte 2 | — | — | 2 | — | — | — |
| Electrolyte 3 | — | — | — | — | 2 | — |
| Particle 1 | 1 | 2 | 2 | — | 2 | 2 |
| Particle 2 | — | — | — | 2 | — | — |

Unit: part(s) by mass

TABLE 6
Surface specific resistivity (ρs)

| | Example | Example | Example | Example | Example | Example |
|---|---|---|---|---|---|---|
| Evaluation item | 1 | 2 | 3 | 4 | 5 | 6 |
| log10 ρs (before | 10.2 | 10.5 | 10.8 | 10.5 | 10.6 | 10.7 |
| continuous | | | | | | |
| energization) | | | | | | |
| log10 ρs (after | 10.2 | 10.6 | 10.8 | 10.4 | 10.6 | 10.8 |
| continuous | | | | | | |
| energization) | | | | | | |
| Increase in | 0.0 | 0.1 | 0.0 | −0.1 | 0.0 | 0.1 |
| resistance after | | | | | | |
| continuous | | | | | | |
| energization in | | | | | | |
| terms of digits | | | | | | |

### Comparative Examples 1 to 3

Seamless belts for electrophotography were obtained in the same manner as in Example 1 with the exception that the blend of the resin composition was changed as shown in Table 7. Table 8 shows the evaluation results of the conductive belts.

TABLE 7

| Comparative Example | 1 | 2 | 3 |
|---|---|---|---|
| Resin for matrix 1 | 81 | 81 | 81 |
| Resin for domain 1 | 15 | 15 | 15 |
| Electrolyte 1 | — | 2 | 2 |
| Electrolyte 4 | 2 | — | — |
| Particle 1 | 2 | — | — |
| Particle 3 | — | — | 2 |

Unit: parts by mass

TABLE 8
Surface specific resistivity (ρs)

| | Comparative | Comparative | Comparative |
|---|---|---|---|
| Evaluation item | Example 1 | Example 2 | Example 3 |
| log10ρs (before | 10.7 | 10.9 | 10.5 |
| continuous | | | |
| energization) | | | |
| log10ρs (after | 11.1 | 11.3 | 10.8 |
| continuous | | | |
| energization) | | | |
| Increase in | 0.4 | 0.4 | 0.3 |
| resistance after | | | |
| continuous | | | |
| energization in | | | |
| terms of digits | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-268601, filed Dec. 7, 2012, which is hereby incorporated by reference herein in its entirety.

What is claimed is:

1. A conductive belt for electrophotography, comprising:
a matrix containing polyester; and
a domain containing polyether ester amide,
wherein:
the conductive belt further comprises a particle containing a silicone resin;
the domain further contains a salt that dissociates into a cation and an anion;
the anion is represented by the following formula (1) or the following formula (2); and
the silicone resin contains a structural unit represented by the following formula (3): 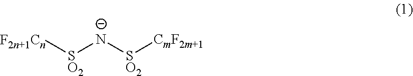
in the formula (1), m and n each independently represent an integer of 1 to 4; 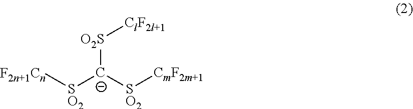
in the formula (2), l, m, and n each independently represent an integer of 1 to 4; and
R₀—SiO_{3/2} (3)
in the formula (3), R₀ represents a hydrocarbon group having 1 to 6 carbon atoms.

2. The conductive belt according to claim 1, wherein, in the formula (3), R₀ represents a methyl group.

3. The conductive belt according to claim 1, wherein the particle containing a silicone resin has an average particle diameter of 1 to 10 μm.

4. The conductive belt according to claim 1, wherein an amount of the particle containing a silicone resin, is 33 parts by mass or more and 500 parts by mass or less with respect to 100 parts by mass of the salt.

5. The conductive belt according to claim 4, wherein an amount of the particle containing a silicone resin, is 100 parts by mass or less with respect to 100 parts by mass of the salt.

6. The conductive belt according to claim 1, wherein the polyester is polyethylene naphthalate or polyethylene terephthalate.

7. The conductive belt according to claim 1, wherein a content of the polyester is 50 mass % or more with respect to a total amount of the polyester and the polyether ester amide.

8. The conductive belt according to claim 1, wherein the conductive belt is used as an intermediate transfer belt for an electrophotographic apparatus.

9. An electrophotographic apparatus, comprising the conductive belt according to claim 1 as an intermediate transfer belt.
